(19) United States
(12) Patent Application Publication
(10) Pub. No.: US 2011/0303035 A1
(43) Pub. Date: Dec. 15, 2011

(54) FINAL DRIVE FOR A WORK MACHINE

(76) Inventors: James A. Niebergall, Buckingham, IA (US); Benjamin L. Borgmann, Waterloo, IA (US); Muthukumar Vallinayagam, Tenkasi (IN); Samantha Hanson, Wateloo, IA (US); Werner Stettler, Cedar Falls, IA (US); Richard N. Knowles, Waterloo, IA (US)

(21) Appl. No.: 13/055,848

(22) PCT Filed: Jul. 31, 2008
(86) PCT No.: PCT/US2008/071776

§ 371 Date: May 9, 2011

(51) Int. Cl. F16H 1/20

(52) U.S. Cl. 74/414

(57) ABSTRACT

A final drive for a work machine includes a housing, a pinion gear, a first idler gear, a second idler gear, and a bull gear. The pinion gear is restrained within the housing. The first idler gear and the second idler gears are rotatably connected to the housing and positioned for engagement with the pinion gear. The bull gear is rotatably connected to the housing and positioned for engagement with the first idler gear and the second idler gear. The housing, the pinion gear, the first idler gear, and the second idler gear are configured to permit the pinion gear to float between the first idler gear, and the second idler to provide even sharing of the load from the pinion gear to the first idler gear and the second idler gear.

### FIELD OF THE INVENTION

The present invention relates to work machines, and, more particularly, to final drives used in such work machines.

### BACKGROUND OF THE INVENTION

A work machine such as an agricultural tractor or a construction tractor may include an internal combustion (IC) engine which provides input power to a transmission, which in turn is coupled with and drives the rear axles through a rear end differential. The rear end differential and rear axles are sometimes referred to as the “rear end” of the work machine.

Some agricultural tractors are equipped with high-crop rear axles that provide high vehicle clearance. The high vehicle clearance is provided by a highly positioned differential, having highly positioned transverse output shafts that connect the differential to final drives. Each of the final drives has a highly positioned input to receive one of the differential output shafts and a lower bull gear that is mounted to a rear axle. Each of the transverse differential output shafts connect to a pinion shaft in one of the two final drives. The pinion shaft of each final drive has gear teeth that engage with teeth on two idler gears. Teeth on the idler gears engage teeth on the bull gear that is connected to the rear axle.

While, in theory, each of the idler gears transfers one half of the torque from the pinion to the bull gear, in practice, due to manufacturing tolerances of the housing, the pinion gear, the idler gears, and the bull gears, one of the idler gears may transfer as much as seventy percent of the torque of the pinion gear to the bull gear. Since the torque is transferred by the few engaged gear teeth of the gears and since the teeth of each of the gears must have the same pitch to mesh with each other, each of the gears must be designed with larger teeth that can transfer the seventy percent of the torque of the pinion gear. Further, the larger teeth require a larger housing and the bearings that support the gears must be large enough to provide sufficient bearing life for the transfer of the seventy percent of the torque of the pinion gear. Consequently, all components in the final drive must be larger than theoretically otherwise needed. Further, the larger gear teeth and larger bearings limit the maximum rotational speed of the gears and, consequently, the maximum speed of the rear axle and the speed of the tractor.

What is needed in the art is a tractor with a final drive that is efficient, permits the use of smaller, lighter weight, less expensive components, and permits higher tractor speeds.

### SUMMARY OF THE INVENTION

The invention in one form is directed to a final drive for a work machine. The final drive includes a housing, a pinion gear, a first idler gear, a second idler gear, and a bull gear. The pinion gear is restrained within the housing. The first idler gear and the second idler gear are rotatably connected to the housing and positioned for engagement with the pinion gear. The bull gear is rotatably connected to the housing and positioned for engagement with the first idler gear and the second idler gear. The housing, the pinion gear, the first idler gear, and the second idler gear are configured to permit the pinion gear to float between the first idler gear and the second idler gear to provide even sharing of the load from the pinion gear to the first idler gear and the second idler gear.

The invention in another form is directed to a work machine including an engine and a rear end coupled with the engine. The rear end includes a rear axle and a final drive attached to the rear axle. The final drive includes a housing, a pinion gear, a first idler gear, a second idler gear, and a bull gear. The pinion gear is restrained within the housing. The first idler gear and the second idler gear are rotatably connected to the housing and positioned for engagement with the pinion gear. The bull gear is rotatably connected to the housing and positioned for engagement with the first idler gear and the second idler gear. The housing, the pinion gear, the first idler gear, and the second idler gear are configured to permit the pinion gear to float between the first idler gear and the second idler gear, to provide even sharing of the load from the pinion gear to the first idler gear and the second idler gear.

### BRIEF DESCRIPTION OF THE DRAWINGS

FIG. 1 is a cross-sectional plan view of an exemplary embodiment of a final drive of the present invention used in an agricultural tractor;

FIG. 2 is a perspective view of the rear axle and final drive assembly of an exemplary embodiment of the present invention including the final drive of FIG. 1;

FIG. 3 is a cross-sectional view of FIG. 2, along the line 3-3 in the direction of the arrows, showing the components of the rear axle and final drive assembly in greater detail;

FIG. 4 is a partial cross-sectional view of FIG. 3, showing the components of the final drive in greater detail;

FIG. 5 is an enlarged, partial cross-section view of FIG. 3, showing the pinion gear and final drive housing interface in greater detail;

FIG. 6 is a partial, exploded perspective view of FIG. 2, showing the pinion gear and one of the idler gears in greater detail;

FIG. 7 is a partial perspective view, partially in cross-section, of FIG. 2, showing the pinion gear in greater detail; and

FIG. 8 is a partial, cross-sectional view of FIG. 3, showing the rear axle of the final drive in greater detail.

### DETAILED DESCRIPTION OF THE INVENTION

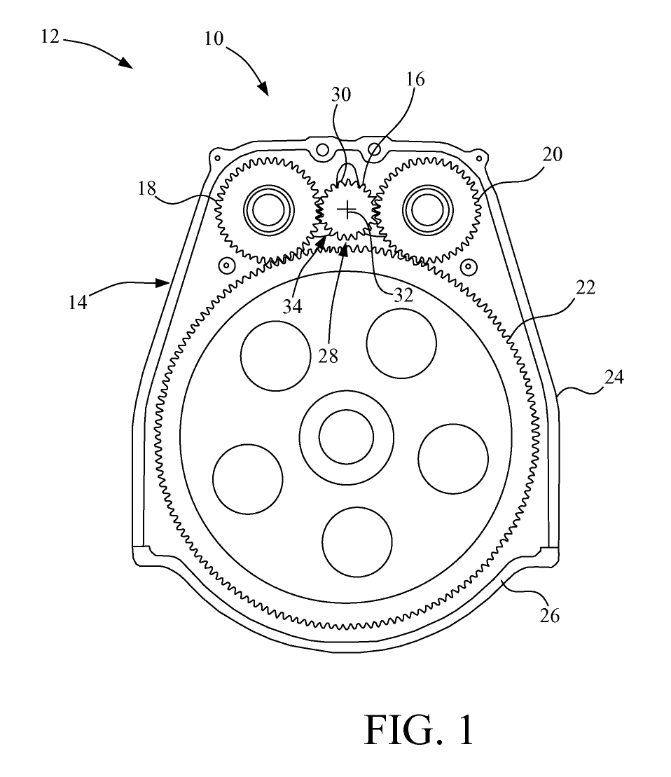

According to the present invention and referring now to FIG. 1, a final drive 10 for a work machine 12 is shown. The final drive 10 includes a housing 14 and a pinion gear 16 restrained within the housing 14. The work machine 12 may be, for example, in the form of an agricultural tractor or a construction vehicle. The final drive 10 serves to transfer torque to the work machine 12.

The final drive 10 further includes a first idler gear 18 rotatably connected to the housing 14 and positioned for meshing engagement with the pinion gear 16. The final drive 10 further includes a second idler gear 20 rotatably connected to the housing 14 and positioned for meshing engagement with the pinion gear 16. The final drive 10 further includes a bull gear 22.

The bull gear 22 is rotatably connected to the housing 14 and positioned for meshing engagement with the first idler gear 18 and the second idler gear 20. The housing 14, the pinion gear 16, the first idler gear 18, and the second idler gear 20 are configured to permit the pinion gear 16 to float between the first idler gear 18 and the second idler gear 20 to result in gear forces between the pinion gear 16 and the first idler gear 18 and between the pinion gear 16 and the second idler gear 20 being equal to each other.

The housing 14 may have any suitable shape capable of receiving the gears 16, 18, 20, and 22. The housing 14 may be made of any suitable durable material and may, for example, be made of a casting, for example a gray iron casting. The housing 14 may be made of multiple components and, as shown, includes an upper interior housing portion 24 and an upper exterior housing portion (not shown) similar to the upper interior housing portion 24. The housing 14 further includes a lower housing portion 26. The multiple housing portions 24 and 26 provide access to the interior portion of the housing 14 to permit assembly of the gears 16, 18, 20, and 22 into the final drive 10.

The pinion gear 16, the first idler gear 18, the second idler gear 20, and the bull gear 22 may be made of any suitable durable material and may, for example, be made of a steel and may be machined by conventional machining processes. The gears 16, 18, 20, and 22 may, for example and for simplicity, be in the form of spur gears having external teeth in the form of gear teeth.

For example and as shown in FIG. 1, the pinion gear 16 includes a portion 28 having external gear teeth 30. The pinion gear 16 defines an axis of rotation 32 thereof. The pinion gear 16 is movable in a direction normal to the axis of rotation 32 of the pinion gear 16 at a position 34 adjacent the portion 28 of the pinion gear 16 having external gear teeth 30. The pinion gear 16 is movable a sufficient amount to assure that the forces transferred from the pinion 16 to the first idler gear 18 and from the pinion 16 to the second idler gear 20 are substantially the same. Such equalization of forces is possible since the pinion gear 16 is permitted to move in a direction normal to the axis of rotation 32 of the pinion gear 16 an amount sufficient to balance the forces between the first idler gear 18 and the second idler gear 20.

The amount of normal movement of the pinion gear 16 needed depends on the precision of the components of the final drive 10. For example, the amount of motion in a direction normal to the axis of rotation 32 of the pinion gear 16 required depends on the precision of the first idler gear 18 and the second idler gear 20, as well as, the precision of the housing bores, bearings, and shafts used to mount the first idler gear 18 and the second idler gear 20 to the housing 14.

For example, the pinion gear 16 may be movable, for example, at least 0.10 to 1.0 millimeters in a direction normal to the axis of rotation 32 of the pinion gear 16 at the position 28 adjacent the gear teeth 30 of the pinion gear 16. For example, the pinion gear 16 may, alternately, be movable from about 0.2 to 0.8 millimeters in a direction normal to the axis of rotation 32 of the pinion gear 16, or may, alternatively, be movable at least 0.50 millimeters in a direction normal to the axis of rotation 32 of the pinion gear 16.

The pinion gear 16, the first idler gear 18, the second idler gear 20 and the bull gear 22 each include external gear teeth 30. The teeth 30 of the gears 16, 18, 20, and 22, preferably, have the same pitch such that the gears 16, 18, 20, and 22 may mesh and rotate as a gear train. The first idler gear 18, the second idler gear 20, and the bull gear 22 are rotatably connected to the housing 14 in any suitable fashion. For example and as shown in the figures, the gears 18, 20, and 22 are supported by rotating element bearings (described in greater detail later herein) which accurately and durably support the gears 18, 20, and 22 within the housing 14.

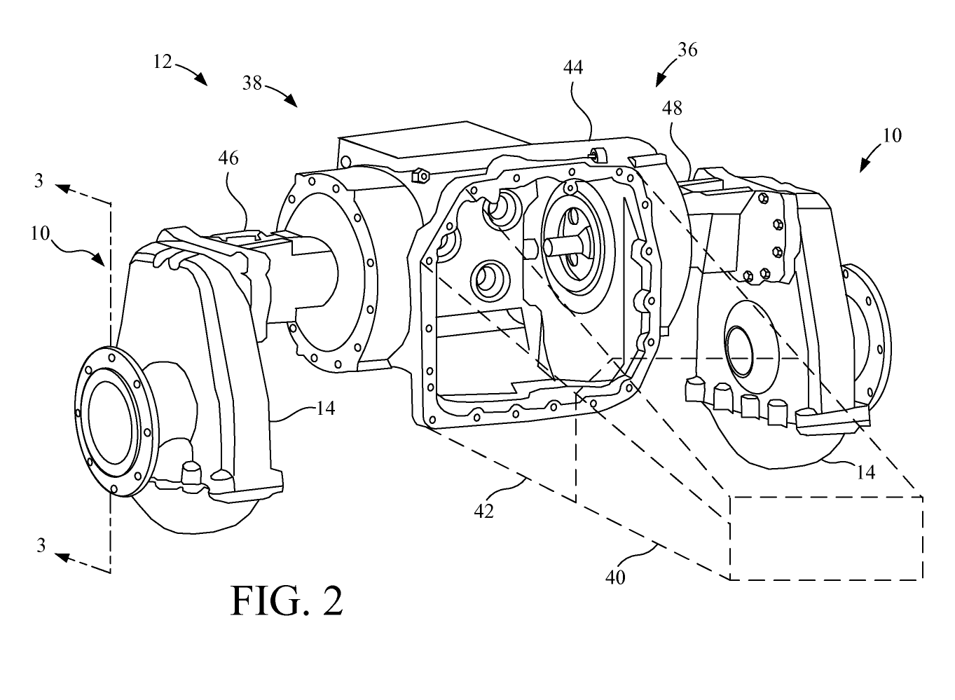

Referring now to FIG. 2, the final drive 10 of the present invention is shown connected to differential 36 to form rear end 38. The rear end 38 is a portion of work machine 12. The work machine 12, as shown in FIG. 2, includes an engine 40. The engine 40 may be any suitable engine and may, for example, be a gasoline or diesel reciprocating piston engine. The engine 40 may be turbocharged or have its power enhanced by one of several various engine devices.

The work machine 12, as shown in FIG. 2, further includes a transmission 42 coupled to the engine 40. The transmission 42 may be a manual or automatic transmission. The transmission 42, as shown in FIG. 2, is connected or coupled to differential 36. The differential 36 includes a differential housing 44. A right intermediate housing 46 mounts onto differential housing 44 and connects the differential housing 44 to the right one of the two final drive housings 14.

Similarly, a left intermediate housing 48 mounts onto differential housing 44 and connects the differential housing 44 to the second of the two final drive housings 14. The left intermediate housing 48 is identical to the right intermediate housing 46. Alternatively, the left intermediate housing 48 is similar to or substantially different than the right intermediate housing 46.

The two final drives 10 are, for simplicity, identical to each other. One of the two final drives 10 is used for the right side of the work machine 12 and the other final drive 10 is used for the left side of the work machine 12. It should be appreciated that the final drives 10 may be different on the left and right side of the work machine 10 and may, for example, be symmetrical or be significantly different from each other.

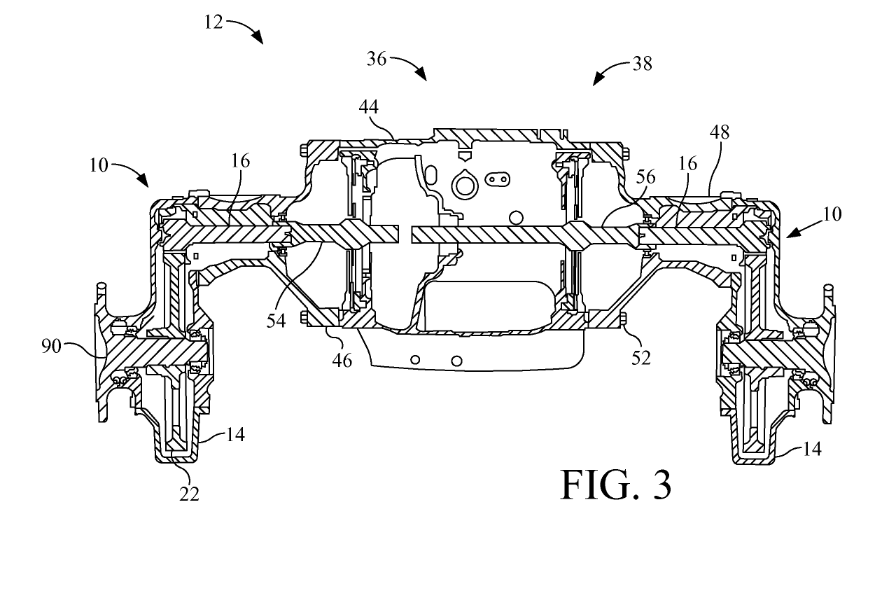

Referring now to FIG. 3, the rear end 38 of the work machine 12 is shown in greater detail in cross-section. The differential housing 44 supports the components of the differential 36. The right intermediate housing 46 and the left intermediate housing 48 are secured to the differential housing 44 in an appropriate manner, for example by fasteners in the form of cap screws 52. The right intermediate housing 46 includes a right intermediate shaft 54, while the left intermediate housing 48 includes a left intermediate shaft 56. The intermediate shafts 54 and 56 transfer power from the differential 36 to the final drives 10.

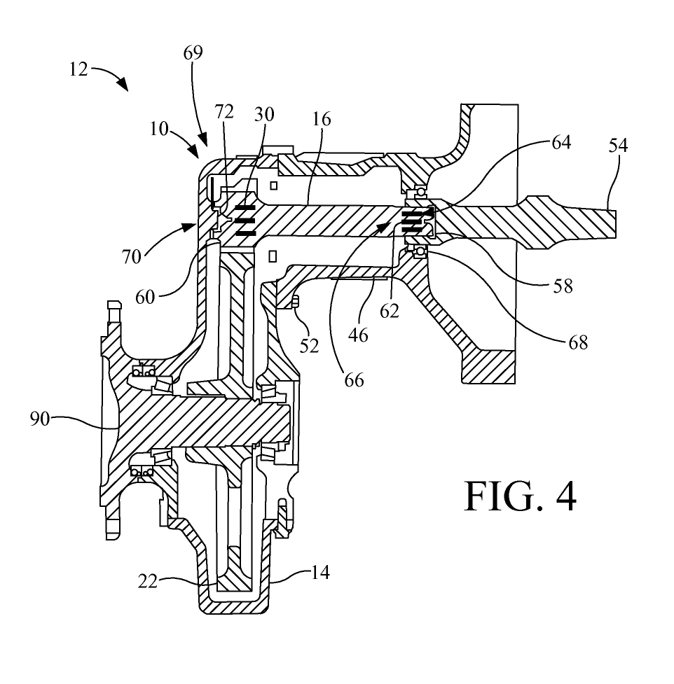

Referring now to FIG. 4, the final drive 10 is shown in greater detail. It should be appreciated that the final drive 10, as shown in FIG. 4, is positioned on the right side of the work machine 12 and may be described as the right final drive. The left final drive is positioned on the left side of the work machine 12 and is identical to the right final drive.

The pinion gear 16 of the final drive 10 includes a first end 58 and an opposed second end 60. The pinion gear 16 is supported at the first end 58. For example and as shown in FIG. 4, the first end 58 of the pinion gear 16 includes an external spline 62 which mates with internal spline 64 formed in recess 66 of right intermediate shaft 54. The right intermediate shaft 54 is rotatably secured to right intermediate housing 46 by bearings 68 in the form of ball type bearings. Other types of bearings may, alternatively, be used. The pinion gear 16 includes the external gear teeth 30 positioned adjacent the second end 60 of the pinion gear 16.

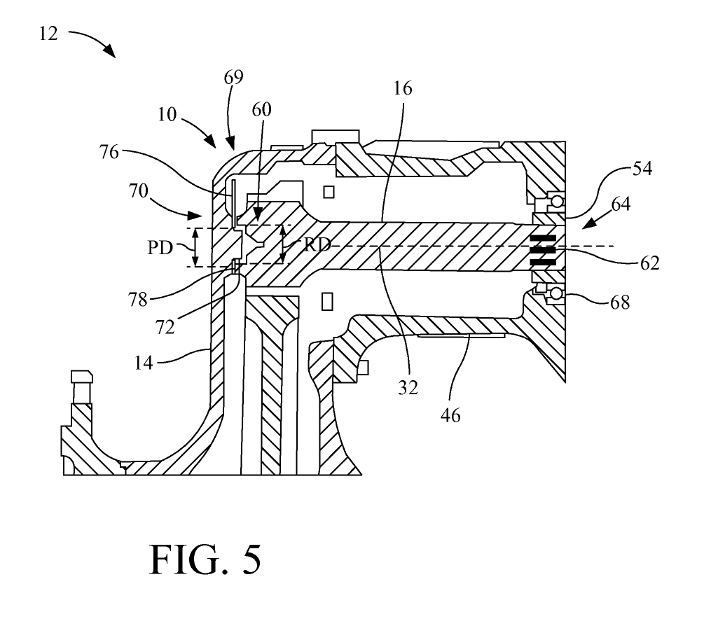

Referring now to FIG. 5, the pinion gear 16 is shown in greater detail in cooperation with the final drive housing 14. The final drive 10 includes a feature 69 for supporting the second end 60 of the pinion gear 16 while permitting the second end 60 to move normally to the axis of rotation 32 of the pinion gear 16. The feature 69 includes a pinion gear recess 70 formed in the second end 60 of the pinion gear 16. The feature 69 also includes a protrusion 72 extending inwardly on final drive housing 14. The recess 72 of the pinion gear 16 is fitted to receive the protrusion 72 of the housing 16.

The protrusion 72 and the recess 70, as shown, are generally cylindrical. Alternate shapes of the protrusion 72 and the recess 70 may be used. Alternatively, the pinion gear may have the protrusion and the housing may have the recess. The protrusion 72 is defined by protrusion diameter PD and the recess 70 defined by recess diameter RD. It should be appreciated that the protrusion diameter PD is slightly smaller than the recess diameter RD of the pinion gear 16. The difference between the recess diameter RD and the protrusion diameter PD forms a clearance between the pinion gear 16 and the final drive housing 14 to permit movement of the pinion gear 16 in a direction normal to the axis of rotation 32 of the pinion gear 16. It should be appreciated that, for a motion of the pinion gear 16 from the axis of rotation 32 of the pinion gear 16 of 0.050 millimeters, the recess diameter RD must be 0.10 millimeters larger than the protrusion diameter PD.

The radial movement from the axis of rotation 32 of the pinion gear 16 may be further limited by the clearance between the internal spline 64 of the right intermediate shaft 54 and the external spline 62 of the pinion gear 16. The internal bearing clearance of the intermediate housing bearing 68 may further affect the ability of the pinion gear 16 to deflect. The rigidity of the pinion gear 16 and the housings 14 and 46 may further affect the ability of the pinion gear 16 to deflect radially.

The final drive 10 further includes a thrust bearing 76 that is secured to final drive housing 14. The pinion gear 16 includes a face 78 that rotatably cooperates with thrust bearing 76. The thrust bearing 76 may have a unitary construction. The thrust bearing may be made of a soft bearing journal material, such as bronze, or a hard bearing material, such as hardened steel. The thrust bearing 76 may, alternately, be integral with the final drive housing 14.

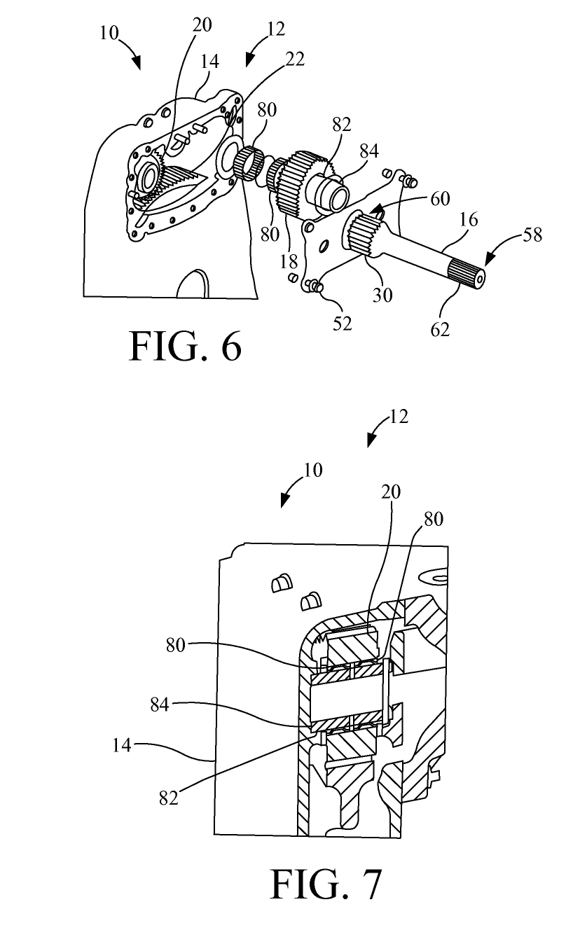

Referring now to FIG. 6, the first idler gear 18 is shown in an exploded view ready for assembly into final drive housing 14. The idler gear 18 includes a pair of spaced apart bearings 80 that, as shown, are in the form of caged needle roller bearings. The bearings 80 rotate on journal 82 of idler shaft 84 that is rigidly secured to final drive housing 14. Other types of bearings may be used. The pinion gear 16 includes the external splines 62 formed on first end 58 of the shaft of the pinion gear 16 and external teeth 30 located on second end 60 of the pinion gear 16.

As shown in FIG. 7, the second idler gear 20 includes a pair of spaced apart needle roller bearings 80 that rotate on journal 82 of idler shaft 84. The shaft 84 is rigidly secured to final drive housing 14. The bearings 80 provide rotatable securing of the second idler gear 20 to the final drive housing 14.

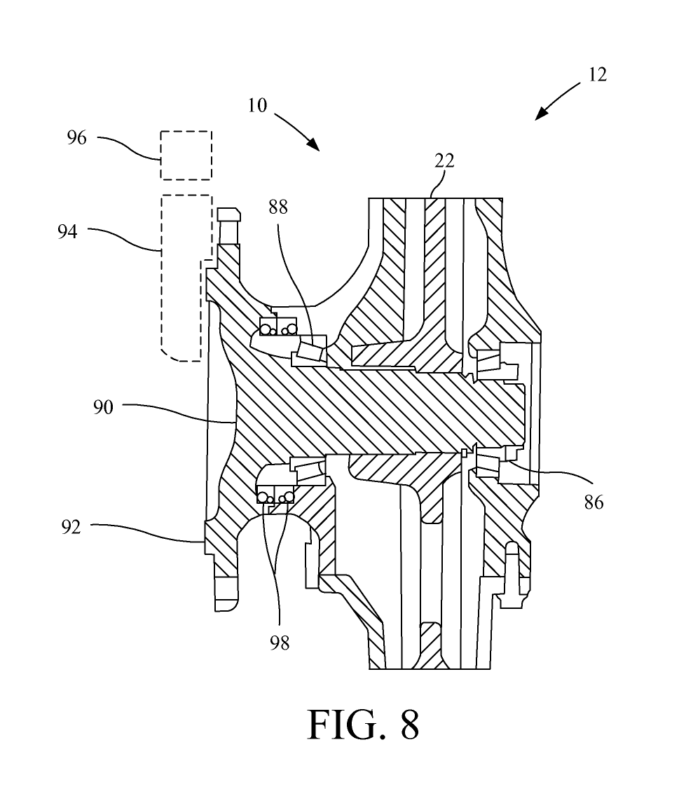

Referring now to FIG. 8, the bull gear 22 is shown in even greater detail. The bull gear 22 is rotatably secured to the final drive housing 14 by inboard bearing 86 and outboard bearing 88. The inboard bearing 86 and outboard bearing 88 are in the form of tapered roller bearings. Alternately, the bearings 86 and 88 may be cylindrical bearings, spherical roller bearings, or ball bearings. Further, other bearings may be used.

The bull gear 22 is rigidly connected to rear axle 90 to which the inboard bearing 86 and the outboard bearing 88 are secured. The rear axle 90 includes an outboard hub 92 to which a wheel 94 is mounted. A rubber tire 96 is mounted onto the wheel 94. The hub 92 of the rear axle 90 is secured to the final drive housing 14 by a pair of opposed angular contact bearings 98.

Having described the preferred embodiment, it will become apparent that various modifications can be made without departing from the scope of the invention as defined in the accompanying claims.

1. A final drive for a work machine, comprising:
a housing;
a pinion gear restrained within said housing;
a first idler gear rotatably connected to said housing and positioned for engagement with said pinion gear;
a second idler gear rotatably connected to said housing and positioned for engagement with said pinion gear; and
a bull gear rotatably connected to said housing and positioned for engagement with said first idler gear and said second idler gear; said housing, said pinion gear, said first idler gear, and said second idler gear configured to permit said pinion gear to float between said first idler gear and said second idler gear, to provide even sharing of the load from the pinion gear to the said first idler gear and said second idler gear.

2. The final drive of claim 1, wherein said pinion gear includes a first end and an opposed second end, said pinion gear rotatably connected to said housing at the first end, said pinion gear including external gear teeth positioned adjacent the second end.

3. The final drive of claim 1, wherein said pinion gear includes a portion having external gear teeth, said pinion gear defining an axis of rotation thereof, said pinion gear being moveable at least 0.50 millimeters in a direction normal to the axis of rotation at a position adjacent the portion having the external gear teeth.

4. The final drive of claim 1:
wherein said pinion gear includes a first end and an opposed second end, said pinion gear supported at the first end, said pinion gear including external gear teeth positioned adjacent the second end, the second end defining a recess therein; and
wherein said housing includes a protrusion, the recess of the second end of said pinion gear fitted to receive the protrusion of said housing.

5. The final drive of claim 4:
wherein the recess of the second end of said pinion gear defines a cylindrical inner periphery thereof; and
wherein the protrusion of said housing defines a cylindrical outer periphery thereof.

6. The final drive of claim 5:
wherein the cylindrical inner periphery the recess of the second end of said pinion gear defines a recess diameter thereof; and
wherein the protrusion of said housing defines a defines a protrusion diameter thereof, the recess diameter being at least 0.50 millimeters larger than the protrusion diameter.

7. The final drive of claim 1:
wherein said pinion gear includes a first end and an opposed second end, said pinion gear including an internal spline positioned adjacent the first end; and
further comprising a shaft, said shaft defining a recess therein, the internal spline of said pinion gear fitted to the recess of said shaft, said shaft rotatably secured to said housing adjacent the recess of said shaft.

8. The final drive of claim 1, wherein said pinion gear includes a portion having external gear teeth, said pinion gear defining an axis of rotation thereof, said pinion gear being moveable at least 0.50 millimeters in a direction normal to the axis of rotation at a position adjacent the portion having the external gear teeth.

9. The final drive of claim 1, wherein at least one of said pinion gear, said first idler gear, said second idler gear, and said bull gear comprises a spur gear.

10. The final drive of claim 1, wherein at least one of said pinion gear, said first idler gear, said second idler gear, and said bull gear is fabricated by hobbing and shaving.

11. A rear end for a work machine, comprising:
a rear axle; and
a final drive attached to the rear axle, the final drive including,
a housing;
a pinion gear restrained within said housing;
a first idler gear rotatably connected to said housing and positioned for engagement with said pinion gear;
a second idler gear rotatably connected to said housing and positioned for engagement with said pinion gear; and
a bull gear rotatably connected to said housing and positioned for engagement with said first idler gear and said second idler gear, said housing, said pinion gear, said first idler gear, and said second idler gear configured to permit said pinion gear to float between said first idler gear and said second idler gear, to provide even sharing of the load from the pinion gear to the said first idler gear and said second idler gear.

12. The rear end of claim 11, The final drive of claim 1, wherein said pinion gear includes a first end and an opposed second end, said pinion gear rotatably connected to said housing at the first end, said pinion gear including external gear teeth positioned adjacent the second end.

13. The rear end of claim 11, wherein said pinion gear includes a portion having external gear teeth, said pinion gear defining an axis of rotation thereof, said pinion gear being moveable at least 0.50 millimeters in a direction normal to the axis of rotation at a position adjacent the portion having the external gear teeth.

14. The rear end of claim 11:
wherein said pinion gear includes a first end and an opposed second end, said pinion gear supported at the first end, said pinion gear including external gear teeth positioned adjacent the second end, the second end defining a recess therein; and
wherein said housing includes a protrusion, the recess of the second end of said pinion gear fitted to receive the protrusion of said housing.

15. The rear end of claim 14:
wherein the recess of the second end of said pinion gear defines a cylindrical inner periphery thereof; and
wherein the protrusion of said housing defines a cylindrical outer periphery thereof.

16. The rear end of claim 15:
wherein the cylindrical inner periphery the recess of the second end of said pinion gear defines a recess diameter thereof; and
wherein the protrusion of said housing defines a defines a protrusion diameter thereof, the recess diameter being at least 0.50 millimeters larger than the protrusion diameter.

17. The rear end of claim 11:
wherein said pinion gear includes a first end and an opposed second end, said pinion gear including an internal spline positioned adjacent the first end; and
further comprising a shaft, said shaft defining a recess therein, the internal spline of said pinion gear fitted to the recess of said shaft, said shaft rotatably secured to said housing adjacent the recess of said shaft.

18. The rear end of claim 11, wherein said pinion gear includes a portion having external gear teeth, said pinion gear defining an axis of rotation thereof, said pinion gear being moveable at least 0.50 millimeters in a direction normal to the axis of rotation at a position adjacent the portion having the external gear teeth.

19. The rear end of claim 11, wherein at least one of said pinion gear, said first idler gear, said second idler gear, and said bull gear comprises a spur gear.

20. The rear end of claim 11, wherein at least one of said pinion gear, said first idler gear, said second idler gear, and said bull gear is fabricated by hobbing and shaving.

21. A work machine, comprising:
an engine; and
a rear end coupled with said engine, said rear end including:
a rear axle; and
a final drive attached to the final drive including,
a housing;
a pinion gear restrained within said housing;
a first idler gear rotatably connected to said housing and positioned for engagement with said pinion gear;
a second idler gear rotatably connected to said housing and positioned for engagement with said pinion gear; and
a bull gear rotatably connected to said housing and positioned for engagement with said first idler gear and said second idler gear; said housing, said pinion gear, said first idler gear, and said second idler gear configured to permit said pinion gear to float between said first idler gear and said second idler gear, to provide even sharing of the load from the pinion gear to the said first idler gear and said second idler gear.

22. The work machine of claim 21, wherein said pinion gear includes a first end and an opposed second end, said pinion gear rotatably connected to said housing at the first end, said pinion gear including external gear teeth positioned adjacent the second end.

23. The work machine of claim 21, wherein said pinion gear includes a portion having external gear teeth, said pinion gear defining an axis of rotation thereof, said pinion gear being moveable at least 0.50 millimeters in a direction normal to the axis of rotation at a position adjacent the portion having the external gear teeth.

24. The work machine of claim 21:
wherein said pinion gear includes a first end and an opposed second end, said pinion gear supported at the first end, said pinion gear including external gear teeth positioned adjacent the second end, the second end defining a recess therein; and
wherein said housing includes a protrusion, the recess of the second end of said pinion gear fitted to receive the protrusion of said housing.

25. The work machine of claim 24:
wherein the recess of the second end of said pinion gear defines a cylindrical inner periphery thereof; and
wherein the protrusion of said housing defines a cylindrical outer periphery thereof.

26. The work machine of claim 25:
wherein the cylindrical inner periphery the recess of the second end of said pinion gear defines a recess diameter thereof; and
wherein the protrusion of said housing defines a defines a protrusion diameter thereof, the recess diameter being at least 0.50 millimeters larger than the protrusion diameter.

27. The work machine of claim 21:
wherein said pinion gear includes a first end and an opposed second end, said pinion gear including an internal spline positioned adjacent the first end; and
further comprising a shaft, said shaft defining a recess therein, the internal spline of said pinion gear fitted to the recess of said shaft, said shaft rotatably secured to said housing adjacent the recess of said shaft.

28. The work machine of claim 21, wherein said pinion gear includes a portion having external gear teeth, said pinion gear defining an axis of rotation thereof, said pinion gear being moveable at least 0.50 millimeters in a direction normal to the axis of rotation at a position adjacent the portion having the external gear teeth.

29. The work machine of claim 21, wherein at least one of said pinion gear, said first idler gear, said second idler gear, and said bull gear comprises a spur gear.

30. The work machine of claim 21, wherein at least one of said pinion gear, said first idler gear, said second idler gear, and said bull gear is fabricated by hobbing and shaving.
